(19) United States
(12) Patent Application Publication
(10) Pub. No.: US 2012/0080579 A1
(43) Pub. Date: Apr. 5, 2012

(54) AIR-ASSISTED HEAVY EQUIPMENT SUPPORT STAND

(75) Inventor: Richard Thomas FRANCIS, Smithville, MO (US)

(73) Assignee: Gray Manufacturing Company Inc., St. Joseph, MO (US)

(21) Appl. No.: 13/251,600

(22) Filed: Oct. 3, 2011

Related U.S. Application Data
(60) Provisional application No. 61/389,246, filed on Oct. 3, 2010.

(51) Int. Cl. F16M 11/28

(52) U.S. Cl. 248/404

(57) ABSTRACT

A heavy equipment support stand is provided have a piston therein for air pressure assisted raising and lowering of the support and having an insert support pin guide connected to the stand to direct the movement of a support pin into and out of the stand.

### CROSS-REFERENCE TO RELATED APPLICATIONS

This application claims priority to U.S. Provisional Application Ser. No. 61/389,246 filed Oct. 3, 2010 titled Air-assisted Heavy Equipment Support Stand.

### BACKGROUND OF THE INVENTION

Heavy equipment utilized in land fills and other waste industry applications is comprised of large and heavy vehicles. Maintenance and service of this equipment is difficult because of the weight and compact design. Thus, the design of support stands, also known as jack stands, required to support this type of heavy equipment must include substantial, heavy parts and support members. Such weighty parts can be difficult to adjust when the support stand is positioned underneath a large earth moving vehicle where the space in which to work is limited and confined.

Support stands require three main components, a base, a saddle and pinning or retention system. The support stands are normally used underneath low slung type vehicles, where head room and working conditions are limited. When servicing and maintaining large equipment such as bulldozers, rippers, excavators, articulated trucks, wheel loaders and wheeled soil compactors, a high capacity support stand is required. A high capacity stand is capable of supporting the tons of weight presented by these large vehicles and therefore is comprised of parts that are both heavy and substantial in size. The size and weight of these support stand parts make them difficult to adjust during use in the limited and confined space of these low-slung vehicles.

### SUMMARY OF THE INVENTION

The heavy equipment support stand described herein incorporates an air assist feature that allows for vertical adjustment of the extension tube or post having a saddle member thereon with respect to the base within which the tube or post is situated. This adjustment is accomplished by using the application of the compressed air supply commonly available in a machine shop or garage (known as “shop air”) to move an internal piston. The movement of the internal piston causes movement of the post with respect to the base and results in the alignment of the height adjustment holes or voids in the post with the voids in the base. This adjustment aligns the two sets of holes or voids and allows insertion of a pin through both sets of holes or voids to fix the position of the stand support and saddle with respect to the base.

This air-assisted adjustment is accomplished by the technician applying the compressed air to an air valve mounted on the base to apply the compressed air to the piston within the base to move the piston position thereby shifting the tube or post within the base to the desired height to accomplish alignment of the height adjustment holes or voids in the post with the voids in the base. When the desired height is reached such that the holes are aligned, the technician slides the support pin, in one embodiment a dual support pin system, into place. After the pin is in place to lock the position of the tube or post with respect to the base, the vehicle load can be lowered onto the support stand.

A benefit of this embodiment is the elimination of the requirement of manually lifting a heavy post within a confined space while also attempting to align the accurately height adjustment voids of the post with the voids in the base and then holding the post in the selected aligned position while attempting to insert the pin.

The support stand may incorporate an approximate 5 psi “pop off” valve that limits the lifting capacity of the piston to approximately 200 lbs. The approximate 5 psi force also allows the post to be rotated for alignment. In one embodiment a dual retention pin inserts and retracts on a slide rail system. This slide rail system assures that both pins are inserted before supporting a load.

### DESCRIPTION OF THE DRAWINGS

FIG. 1 shows front and right side perspectives with the dual pins removed from insertion into the holes or voids;

FIG. 2 shows a right side elevation view of the support stand with the dual pins partially inserted into the holes or voids of the post, or extension tube; the lower pin being partially inserted into the base hole or void and the upper pin being partially inserted into the base pin crotch;

FIG. 3 shows a left side elevation view of the support stand with the dual pins fully inserted into the post voids and the lower pin fully inserted into the base void and the upper pin fully inserted into the base pin crotch;

FIG. 4 shows a partial left side and rear perspective view of the support stand with the dual pins fully into the voids of the post and the lower pin fully inserted into the base voids and the upper pin fully inserted into the base pin crotches;

FIG. 5 is a bottom and side perspective view of the post with a piston mounted at its bottom and showing the air entryway 48 which permits the air pressure introduced into base 11 to contact the pressure release valve; and

FIG. 6 is a cross-section view taken along Line 6-6 of FIG. 5 and showing the connection of the piston to the bottom of the post and showing the pressure relief valve and adaptor that is positioned inside the stand post.

### DESCRIPTION

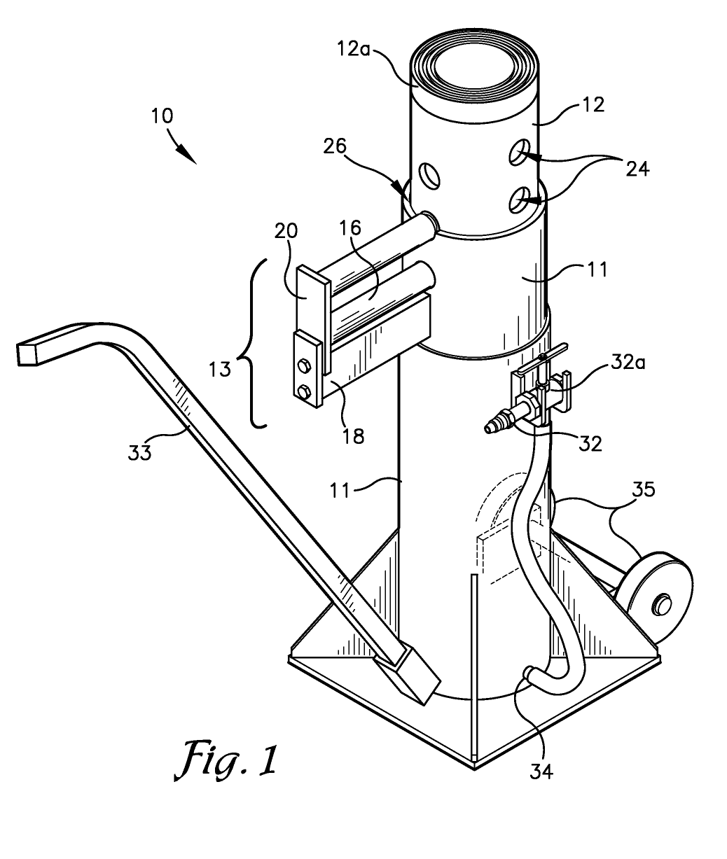

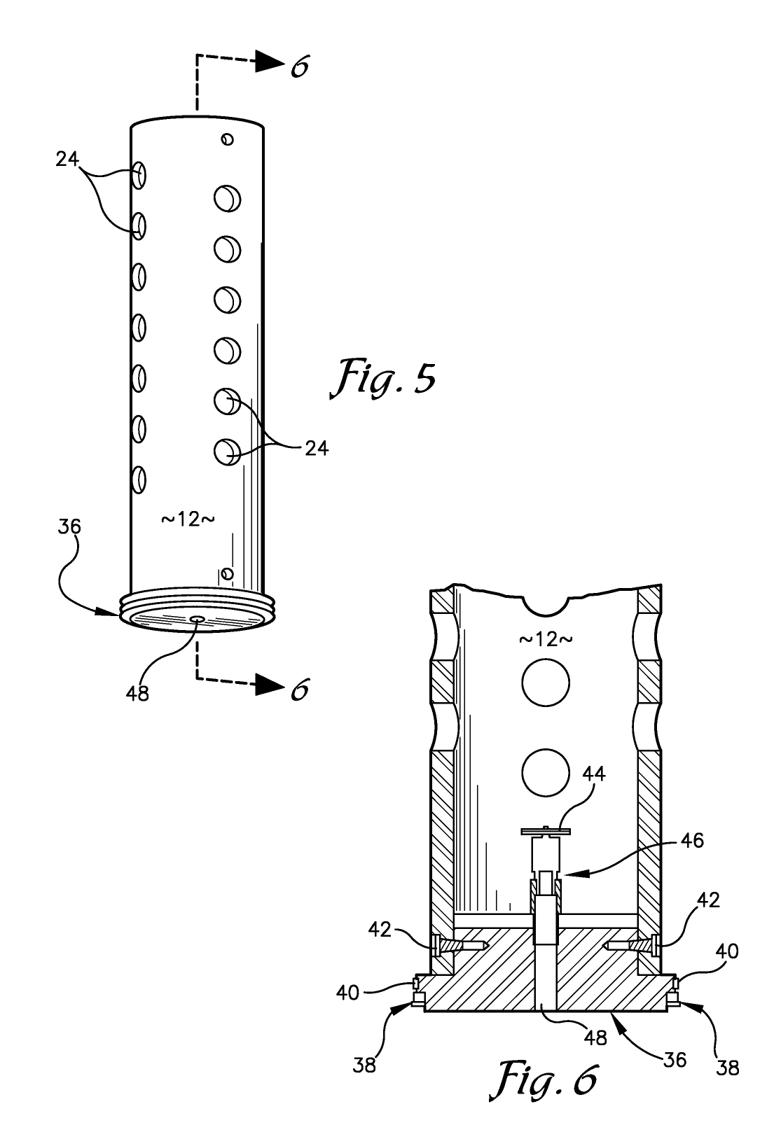

Referring to FIG. 1, support stand 10 is shown comprising base 11 having post or extension tube 12 co-axially inserted into base 11 for in-and-out or telescopic movement with respect to base 11. An upper end of post or extension tube 12 may have a saddle 12a thereon. Post or extension tube 12 also has a bottom end discussed hereinafter in FIGS. 5 and 6 which is provided with a piston 36, the use of which is described hereinafter. Also in FIG. 1 is shown a structure 13 for securing the duel pins together for tandem movement and for preventing vertical and lateral misalignment of the pins as the pins are moved into voids that extend through base 11 and post 12. This is identified hereinafter as the slide rail pin set 13. The slide rail pin set 13 is comprised of upper pin 14, lower pin 16 and arm or slide rail 18 and flange 20. In FIG. 1, it can be observed that upper pin 14 has a first end connected to flange 20 and a second end which, in a withdrawn position, contacts the top of base 11. It may be seen in FIG. 1 that lower pin 16 has a first end which is connected to flange 20 and a second end which is partially extending into base 11. Upper pin 14 and lower pin 16 are connected to flange 20 and it is flange 20 which moves along the length of slide rail 18 as pins 14, 16 are inserted into base 11 or withdrawn therefrom. Flange 20 is provided with a slot or an indent that is mateable or registerable with slide rail 18 for guiding slideable movement of flange 20 along slide rail 18 to thereby prevent unwanted vertical angling or lateral (side to side) angling of pins 14, 16 as they are inserted into base 11 or withdrawn therefrom. It will be appreciated that the connection to flange 20 causes pins 14, 16 to move simultaneously and that flange 20 traveling along slide rail 18 avoids up or down or side ways movement of the pins so that insertion of pins 14, 16 accurately moves across the diameter of base 11 and post 12 for insertion of pins 14, 16 into and through voids on the opposite side of base 11 and post 12.

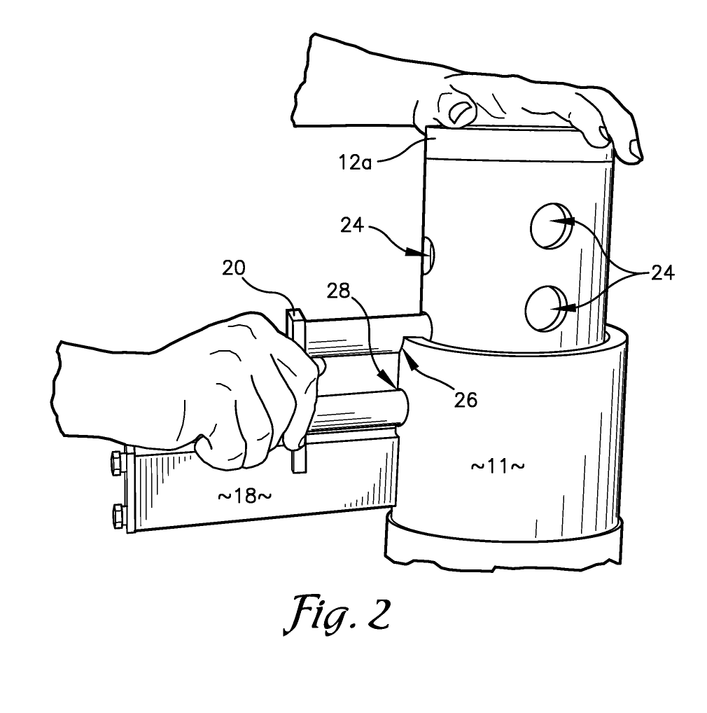

Referring now to FIG. 2, post or extension tube 12 is seen partially withdrawn from (or inserted into) base 11. Post or extension tube 12 is provided with post voids 24 which may be provided as plurality of vertical sets of post voids spaced about the circumference, or separated by approximately ninety degrees about the circumference, of post 12. Each set of post voids comprises a first void on one side of post 12 and a second post void diametrically opposed to the first post void such that insertion of one of pins 14, 16 may enter a post void on one side of post 12 and travel through the diameter of post 12 to contact and enter into the diametrically opposed post void. In FIG. 2, saddle 12a, is shown on a top end of post 12. It will be appreciated that post 12 is rotatable within base 11. By such rotation, post voids 24 which were unaligned with pins 14, 16 may be aligned with pins 14, 16 as a result of rotation of post 12 within base 11. It also will be appreciated in FIG. 2 that upper pin 14 partially rests in a depression or crotch 26 in the upper edge of base 11. Crotch 26 is shaped to be complimentary in shape to pin 14 to receive pin 14 therein and to allow pin 14 to slide across the surface of crotch 26 (better viewed in FIG. 4) and into post void 24. Due to the connection of pin 14 and pin 16 to flange 20, the entry of both pins 14, 16 into post voids 24 is coordinated as flange 20 slides along the length of slide rail 18. As previously described, this coordinated entry is guided by the grooved or slotted bottom of flange 20 which engages slide rail 18 therein to prevent both pitch and front-to-rear angle of entry misalignment of pins 14, 16 during travel which could result in misalignment of pins 14, 16 with voids 24 and prevention of insertion of the pins.

Referring to FIG. 4, a crotch 26 is shown as being present on the opposite side of base 11 for receiving pin 14. Only the upper half of pin 14 is visible in FIG. 4 as the lower half of pin 14 is seated within crotch 26. Referring now to FIG. 2, it will be appreciated that base 11 also includes a void 28 positioned immediately above slide rail 18 and oriented to receive lower pin 16 therein as flange 20 is pressed inwardly to travel across slide rail 18 toward base 11. It will be appreciated by those skilled in the art that the insertion of pin 14 into pin crotch 26 and pin 16 into base void 28 is permitted by close registration between post voids 24 and base crotch 26 and base void 28. The close registration allows for smooth insertion of pin 14, 16 into base crotch 26 and base void 28 initially, and then into the post voids 24 are positioned in line with slide rail 18. Farther insertion of pins 14, 16 into post voids results in the movement of pins 14, 16 across the diameter of post 12 to contact the post void 24 on the opposite side of post 12 from slide rail 18. Insertion is completed by the entry of pins 14, 16 into base crotch 26 and base void 28 which are on the opposite side of base 11 from slide rail 18 (see, FIG. 4).

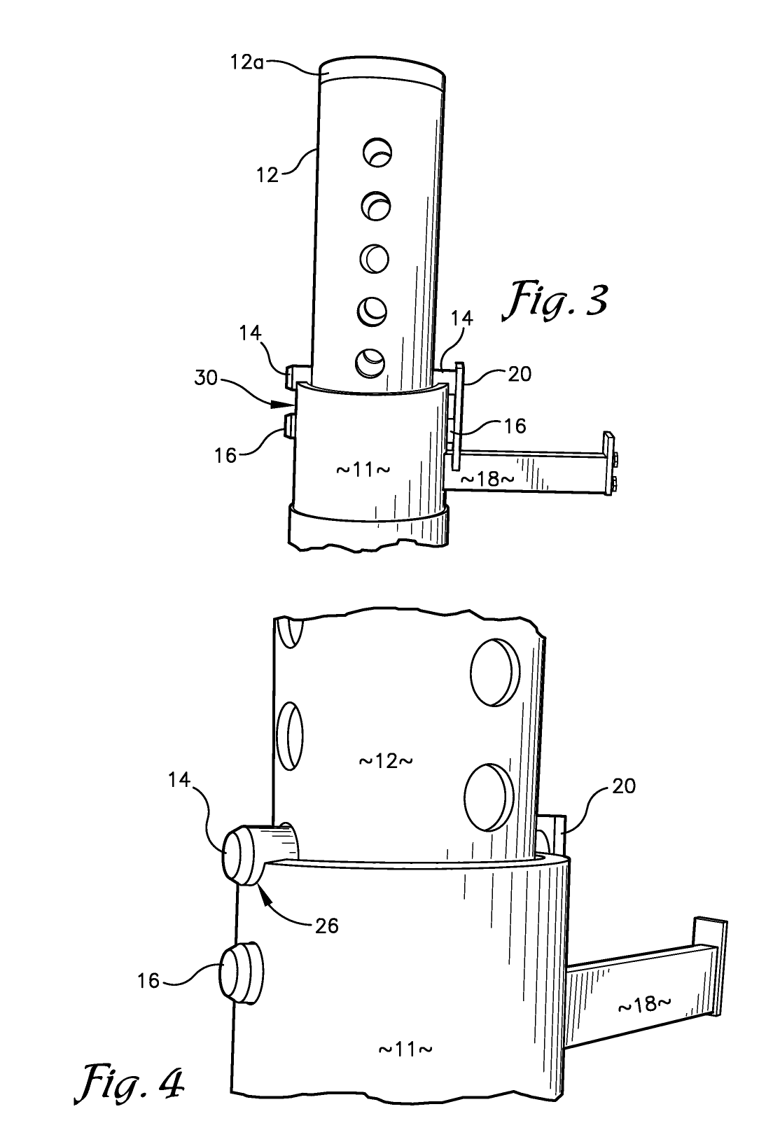

Referring now to FIGS. 3 and 4, the full and complete entry of pins 14, 16 into base 11 and post 12 may be seen. In FIGS. 3 and 4, a close view of the relationship between pins 14, 16 and post voids 24 and base crotch 26 and base void 28 is shown. It will be appreciated by those skilled in the art that a very close registration between post voids 24 and base crotch 26 and base void 28 is required to allow pins 14, 16 to slide across the diameter of both post 12 and base 11 to achieve complete seating of pins 14, 16 within their respective voids. This close registration is achieved by the use of a compressed gas, such as compressed air or shop air, which is introduced into base 11. The pressure of the compressed gas within base 11 increases the pressure against a piston, which comprises the bottom end of post 12, to thereby urge post 12 upwardly as pressure increases, or ease the post downwardly as pressure is reduced within base 11. This movement of post 12 permits the operator of stand 10 to achieve the close registration between voids 24 and crotch 26 and base void 28 necessary to permit insertion of pins 14, 16 as has been described.

Referring now to FIG. 1, an air nipple 32 is shown, which allows attachment of a compressed air hose with a hose connection being made from nipple 32 to air connector 34 which allows the introduction of the compressed gas or shop air into the bottom of base 11. It will be appreciated that base 11, which acts as a cylinder within which the piston travels. Also shown in FIG. 1 is valve 32a which can be used by the operator of stand 10 to add air pressure into base 11 to urge post 12 upward or to bleed air from post 12 to ease post 12 downward. Also shown is handle 33 by which stand 10 may be guided while being moved on wheels 35.

Referring now to FIGS. 5 and 6, the construction of the piston which is connected to the bottom of post 12 will be described. Referring to FIG. 5, piston 36 is shown attached to the bottom of post 12 as previously described. The piston 36 is designed to closely fit into base 11. Base 11 acts as the cylinder within which piston 36 and attached post 12 travel to allow adjustment of post voids 24 into registration with base crotch 26 and base voids 28. In FIG. 6, the components of the piston are shown and which comprise a circumferential seal 38, which operates to retain the air pressure within the cylinder or base 11. Above seal 38 is wear ring 40, which operates to seat piston 36 and post 12 within base 11. Screws 42 retain piston 36 within post 12. Piston 36 also is provided with pressure relief valve 44 which is connected to piston 36 by adaptor 46. The purpose of pressure relief valve 44 is to limit the amount of pressure that can be introduced into base 11 to approximately five (5) pounds per square inch. For pressures above this limit, the pressure relief valve will prevent the sudden and unwanted expulsion of post 12 from being seated within base 11 due to inadvertent application of excessive air pressure to base 11.

In FIG. 6, air void 48 is shown. It is the opening of the passage way through piston 36 to allow the pressurized air that is introduced into base 11 to contact adaptor 46 and pressure relief valve 44.

It will be appreciated by those skilled in the art that base 11 may be provided with two voids as an alternative to crotch 26 and base void 28 to achieve the close registration between voids 24 and the openings in base 11 needed to permit insertion of pins 14, 16 as has been described. It will be appreciated by those skilled in the art that base 11 and post 12 may be provided with a registerable vertical key-way formed by a registerable vertical track in base 11 or post 12 for reception of a vertical projection formed on the other member being either base 11 or post 12 therein to maintain the registration between crotch 26 and base void 28 and post voids 24 and thereby eliminate the need for the previously described rotation of post 12 in base 11.

It will be appreciated by those skilled in the art that a worker looking to place stand 10 underneath a large heavy vehicle such as a bulldozer or excavator will need to adjust post voids 24 into a position such that they are aligned with crotch 26 and base void 28 to allow pins 14, 16 to be inserted through the base 11 and post 12. To permit this fine adjustment of the spatial relationship between post voids 24 and crotch 26 and base void 28, the previously described pressurization of base 11 with compressed air produces movement of post 12 within base 11. As the introduction or removal of compressed gas urges piston 36 to move in response to the gas pressure, the worker by adding compressed gas or removing compressed gas from base 11 can change the height of post 12 within base 11. This produces a resulting change in the position of post voids 24. The worker by manipulating the pressure of gas within base 11 can bring post voids 24 into registration with crotch 26 and base void 28 to permit unobstructed insertion of pins 14, 16 through post voids 24 and crotch 26 and base void 28.

1. A support stand comprising:
a base, having a gas connection thereon to permit an input of a pressurized gas into said base, and said base having at least one pair of diametrically opposed base voids therein,
a post having a first end and a second end, said post being coaxially insertable into said base for telescopic movement with respect to said base, said post having at least one pair of diametrically opposed post voids therein, for registration with said at least one pair of diametrically opposed base voids,
at least one pin having a first end and a second end, said first end for insertion into said at least one pair of diametrically opposed base voids and said at least one pair of diametrically opposed post voids to prevent vertical movement of said post with respect to said base,
a piston connected to said first end of said post, said piston having a void therein for connection to a pressure release valve and said piston forming a gas-tight barrier with the interior of said base for confinement of a gas within said base, said piston being vertically movable within said base in response to said input of said pressurized gas to bring said base voids and said post voids into registration to permit insertion of said pin therethrough.

2. The support stand as described in claim 1 further comprising a second pin having a first end and a second end, said first end for insertion into a second pair of diametrically opposed base voids and a second pair of diametrically opposed post voids.

3. The support stand as described in claim 2 further comprising a flange for securing said at least one pin and said second pin together for tandem pin movement in and out of said base voids and said post voids.

4. The support stand as described in claim 3 further comprising a rail extending from said base for receiving said flange thereon said rail directing the movement of the flange as the pins are moved in and out of said base voids and said post voids.

5. The support stand as described in claim 4 further comprising a valve for controlling the input of pressurized gas into the base and for releasing pressurized gas from said base.

6. The support stand as described in claim 5 further comprising a pressure release connected to said piston.
